(19) United States
(12) Patent Application Publication
(10) Pub. No.: US 2003/0144003 A1
(43) Pub. Date: Jul. 31, 2003

(54) Handling connections in a mobile network

(76) Inventors: Jukka Ranta, Turku (FI); Harri Jokinen, Hiisi (FI); Seppo Rosnell, Salo (FI); Otto-Aleksanteri Lehtiene, Hauppauge, NY (US)

Correspondence Address: Crawford, Suite 390, 1270 Northland Drive, St Paul, MN, 55120, US

(21) Appl. No.: 10/204,101

(22) PCT Filed: Feb. 14, 2001
(86) PCT No.: PCT/FI01/00140

(30) Foreign Application Priority Data
Feb. 17, 2000 (FI) 20000355

(51) Int. Cl. H04Q 7/20

(52) U.S. Cl. 455/450; 455/422

(57) ABSTRACT

The invention relates to a method for handling a connection in a mobile system where a direct mode connection is established between at least two mobile stations (MSA, MSB). The method comprises the steps of allocating an available traffic channel to the direct mode connection through a base station (BS) of the mobile network in response to a call sent by one of the mobile stations (MSA), establishing the direct mode connection between the mobile stations (MSA, MSB), and transmitting information concerning the direct mode connection on a control channel between the base station (BS) of the mobile network and one of the mobile stations (MSA) during the direct mode connection.

The invention relates to establishing and handling a connection between mobile stations and in particular to direct mode operation, where the information to be transmitted does not travel through a mobile network.

A solution is previously known in cellular networks, such as the GSM (Global System for Mobile Communications) network, in which all the information between mobile stations, including the information associated with connection control, is transmitted through a network base station. Thus, data required for resource management, mobility management and billing is also transmitted to the network. Then again, a solution is known for portable radiophones, in which a frequency range is used that is not licensed and in which an appropriate channel is used for transmitting information directly between the radiophones, and not through the network. The TETRA system (Terrestrial Trunked Radio) combines the direct mode operation (DMO) and what is known as the trunking operation, in which a computer-controlled exchange allocates, if necessary, available channels from a common pool to the users. The TETRA system includes mobile stations, which may be in a dual watch mode, where the mobile station, when operating in a first operation mode, is capable of monitoring the second operation mode.

The problems with the above solution are associated with the resource management, mobility management and billing of the licensed frequency range channels. For example, the cellular network is heavily loaded as all the operations associated with connections are carried out through the network. In addition, the mobility of the mobile stations is limited, since connections outside the coverage area of the network cannot be established. In the TETRA system, direct mode connections outside the coverage area of the network can be established, but not billed, as the connections do not transmit the information required for billing to the network. The same applies to portable radiophones in general. Furthermore, the transmission powers used in known radio network solutions may cause interference between cells or within cells.

It is an object of the invention to solve the above problems by offering a solution, which allows to establish and handle connections between mobile stations more efficiently by combining the properties of a cellular network and direct mode operation. The object of the invention is achieved with a method for handling a connection in a mobile system, where a direct mode connection is established between at least two mobile stations. Said method is characterized by comprising the steps of allocating an available traffic channel to the direct mode connection through a base station of the mobile network in response to a call sent by one of the mobile stations, establishing the direct mode connection between the mobile stations, and transmitting information concerning the direct mode connection on a control channel between the base station of the mobile network and one of the mobile stations during the direct mode connection.

The invention also relates to a mobile system, to which the method of the invention can be applied. The mobile system of the invention includes at least two mobile stations comprising means for establishing a direct mode connection, and a mobile network comprising at least one base station. Said mobile system is characterized by at least one of said mobile stations comprising means for producing information concerning a direct mode connection, and means for sending and receiving information concerning the direct mode connection on a control channel of the base station of the mobile network during the direct mode connection, and the base station of the mobile network comprising means for sending and receiving the information concerning the direct mode connection on the control channel during the direct mode connection.

The invention further relates to a mobile station comprising a transceiver arranged to send and receive radio signals on a direct mode channel. Said mobile station is characterized by comprising means for producing information concerning a direct mode connection, and means for sending and receiving information concerning the direct mode connection on a control channel of a base station of a mobile network during the direct mode connection.

The invention is based on the idea that a direct mode connection is established between the mobile stations, and the control channel of the base station of the mobile network is used for transmitting the information concerning the direct mode connection when possible. One of the parties of the direct mode connection establishes a control connection having a low transmission rate to the base station of the mobile network for transmitting the information. This mobile station is referred to as a master. A part of the base station operations, such as power control and data processing concerning handovers, are handed to the master mobile station for handling. The second mobile station, which is referred to as a slave, only has a direct mode connection with the master mobile station. Thus, a lower transmission power level can be used on the traffic channel of the direct mode connection. The invention aims to minimize the signalling taking place through the network and to improve the performance of the cell.

Thus, the most significant advantages of the method, system and mobile station of the invention are that the capacity of the cell improves, meaning that the same channel can be employed elsewhere in the cell and the interferences are reduced when lower transmission power is used, that the network is less loaded when the master mobile station is provided with some of the functions of the base station, that billing can be employed within the network as well as outside the network, that the availability of the cell increases as the second mobile station is able to move away from the coverage area of the base station without handover between the base stations, and that the coverage area of the service improves.

In a preferred embodiment of the invention the slave mobile station operates as a relay of the base station when the master mobile station is outside the coverage area of the network. Then the slave mobile station asks the base station for a traffic channel and relays control data between the master mobile station and the base station after the establishment of the connection. This has the advantage that a connection can be established and that the connection provides the network with information as usually for billing, for example, even if the master mobile station outside the coverage area were a calling mobile station.

In a second embodiment of the method of the invention the direct mode connection is a group connection, in which case one mobile station operates as a master and the others as slaves. Consequently, one mobile station transmits at a time and the others receive. A sending permission is provided on the basis of speech activity.

In a third embodiment of the method of the invention the master and slave roles can be switched during the connection, whereby the original master becomes a slave and the original slave becomes the master. Such a switch may take place, for example, based on such parameters as transmission power, cell capacity, signal-to-noise ratio or path attenuation. The network then decides on the basis of said parameters, which mobile station is better suitable to be the master. Threshold values can be set for the parameters in the network, in which case, for instance, a certain parameter of the master mobile station must be at least one threshold value below the corresponding parameter of the slave mobile station, before the switch from master to slave role can be carried out. If there is good reason to switch roles, the network informs about this on the control channel.

In an embodiment of the mobile station of the invention the mobile station performs measurements for mobility management, on the basis of which the mobile station is able, when moving within the mobile network area during the direct mode connection, to select the best base station channel. When the mobile station moves into the coverage area of another base station, the direct mode connection may start to use a new traffic channel. In this way the connection may continue irrespective of the transfer of master mobile station.

In another embodiment of the mobile station of the invention the mobile station comprises means allowing to switch, if needed, from the direct mode operation to standard cellular network operation during the connection. The mobile station then asks the base station for a traffic channel, and thereafter the connection between the mobile stations is transmitted through the base stations of the network.

The preferred embodiments of the method, system and mobile station of the invention are disclosed in the appended dependent claims.

In the following, the invention will be described in more detail by means of the preferred embodiments with reference to the accompanying drawings, in which

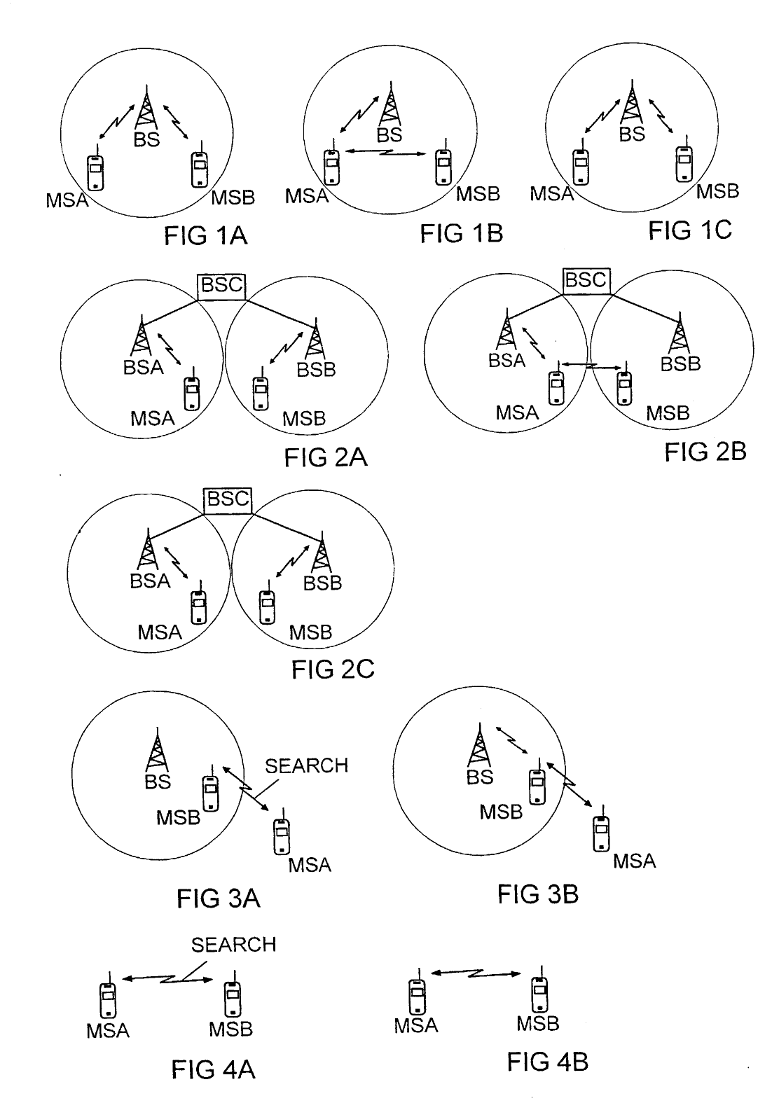

FIGS. 1A to 1C are block diagrams showing a mobile system of the invention in a situation where both mobile stations are within the coverage area of the same base station,

FIGS. 2A to 2C are block diagrams showing a mobile system of the invention in a situation where both mobile stations are within the coverage area of different base stations,

FIGS. 3A to 3B are block diagrams showing a mobile system of the invention in a situation where a master mobile station is outside the coverage area of the mobile network,

FIGS. 4A to 4B are block diagrams showing a mobile system of the invention in a situation where both mobile stations are outside the coverage area of the mobile network, and

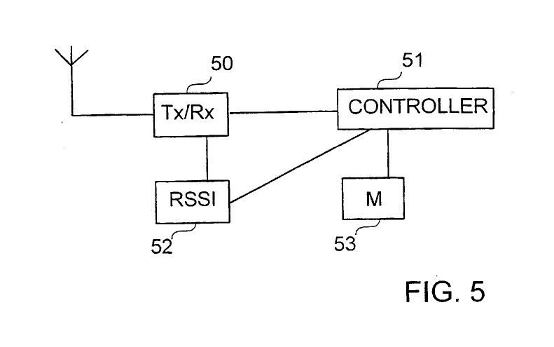

FIG. 5 is a block diagram showing a mobile station of the invention.

FIGS. 1A to 1C are block diagrams showing the mobile system of the invention in a situation where both mobile stations MSA, MSB are within the coverage area of the same base station BS. The part of the mobile system shown comprises a base station BS and two mobile stations MSA, MSB within the coverage area thereof.

A connection is established when the first mobile station MSA sends a call directly to the second mobile station MSB. This call functioning as a handshaking signal may be, for example, a certain bit pattern at a particular frequency, to which the calling mobile station MSA waits for an acknowledgement from the called mobile station MSB. It can also be checked during such a handshaking procedure before the channel request that a direct mode connection can be established. In FIG. 1A the mobile stations MSA, MSB are synchronized through the base station BS by sending synchronization signals that both the mobile stations MSA, MSB receive. Since the mobile stations are within the network area, the synchronization signals and channels of the existing system can be utilized in the synchronization.

In FIG. 1B the calling mobile station MSA sends a call to the network in order to allocate a traffic channel. The network answers this call by indicating the allocated traffic channel appropriate for the direct mode connection and data on the transmission power level. Next, a connection is established between the calling mobile station MSA and the base station BS using a control channel having a low transmission rate for transmitting information concerning, for example, billing, mobility management and the use of traffic channels during the direct mode connection. The control channel can be a dedicated channel or a common channel. The mobile station may be in an ACTIVE mode (not in an IDLE mode) even though it has a control channel connection. The information concerning mobility management may include data on the mode of the direct mode link, which is reported to the network. Based on this information the network decides when it should switch from direct mode to standard cellular network operation mode, where communication is carried out through base stations. The information concerning the use of traffic channels may include data on how active the direct mode link is based on the measurements performed, i.e. for example on the number of time slots used.

The mobile station MSA having a control channel connection with the base station BS during the direct mode connection is referred to as the master of the direct mode connection and the second mobile station MSB is referred to as a slave.

At the end of the connection the base station BS is provided with the information on the release of the traffic channel. Both mobile stations MSA, MSB in the FIG. 1C establish a connection to the network and update the location. Then the mobile station returns to the standard cellular network operation mode.

FIGS. 2A to 2C are block diagrams showing the mobile system of the invention in a situation where both mobile stations MSA, MSB are within the coverage area of the same network but different base stations BSA, BSB. The mobile system part shown comprises two base stations BSA, BSB, a base station controller BSC and a mobile station MSA, MSB within the coverage area of both base stations BSA, BSB.

Connection establishment starts in FIG. 2A, when the mobile stations MSA, MSB are synchronized through the base stations BSA, BSB. The first base station BSA sends a synchronization signal to the calling mobile station MSA and the second base station BSB to the called mobile station MSB. During connection establishment it is also checked that the mobile stations MSA, MSB are close enough to one another for establishing a direct mode connection. This may occur for example through the base station BSA of the calling mobile station MSA and the base station controller BSC by comparing path attenuations.

In FIG. 2B the base station BSB of the called mobile station MSB performs virtual handover, that is hands over the called mobile station MSB to the traffic channel obtained by the calling mobile station MSA together with the information concerning the initial power level. After this the calling mobile station MSA maintains the control channel having a low transmission rate at the base station BSA, in other words operates as the master mobile station. Similar control data is transmitted on the control channel as in the case shown in FIG. 1B.

The master mobile station MSA informs the network that the connection has ended and in FIG. 2C both mobile stations MSA, MSB establish a connection to the network and update the location.

Deviating from the situation shown in FIGS. 2A to 2C, the mobile stations MSA, MSB can also be operating in different mobile networks. Multimode mobile stations, which are able to operate in different networks, may operate in different operation modes. Consequently the data supporting synchronization can be transmitted between different networks during handshaking.

FIGS. 3A to 3B are block diagrams showing the mobile system of the invention in a situation where the calling mobile station, or the master mobile station MSA, is outside the coverage area of the network. The mobile system part shown comprises a base station BS, a calling mobile station MSA outside the coverage area of the base station BS and a called mobile station MSB within the coverage area of the base station BS.

In FIG. 3A the calling mobile station MSA performs paging in order to reach the called mobile station MSB. Paging is performed in accordance with the directions of the network operator so that the amount of interference caused by the paging signal of the calling mobile station MSA and transmitted to the networks close by is kept as low as possible.

When the connection is established, the called mobile station MSA located in the coverage area of the base station BS starts to function as a relay of the base station BS in FIG. 3B. The called mobile station MSB then requests for a traffic channel from the base station BS, and forwards the data on the allocated traffic channel to the calling mobile station MSA. In addition the information concerning the direct mode connection is relayed between the calling mobile station MSA and the base station BS through the called mobile station MSB during the direct mode connection. The control channel is used for transmitting similar control data as shown in FIGS. 1B and 2B. The calling mobile station MSA operates in this case too as the master of the connection. At the end of the connection the called mobile station MSB, or the slave, relays the end information to the master, and thereafter both mobile stations MSA, MSB update the location.

The relaying above can also be used when both mobile stations are within the coverage area of the mobile network. This can be done, for example in cases, where it is more preferable in view of the economical or interference aspects to maintain the slave mobile station in contact with the network as a relay than to maintain the master mobile station in direct contact with the network.

If in contrast to the above example the slave mobile station MSB is outside the network and the master mobile station MSA is within the coverage area of the network, then relaying is not required. Instead, the master mobile station MSA is then in direct contact with the baste station BS on the control channel.

FIGS. 4A to 4B are block diagrams showing the mobile system of the invention in a situation where both mobile stations MSA, MSB are outside the coverage area of the network. The mobile system part shown comprises a calling mobile station MSA and a called mobile station MSB only.

In FIG. 4A the calling mobile station MSA performs paging using a paging signal in order to reach the called mobile station MSB in the same way as shown in FIG. 3A. After establishing the connection, said connection is handled in accordance with the previous cases with the exception of the control channel of the base station having a low transmission rate that is not used in this case.

In FIG. 4B the direct mode connection is established between the mobile stations MSA, MSB. During the connection the mobile station MSA produces and stores the information concerning the direct mode connection required for billing, for example. This information is stored for instance in a SIM card of the calling mobile station MSA until it is transmitted through the base station to the network. The transmission of the information on the direct mode connection may take place immediately after the end of the direct mode connection or later, but also repeatedly in smaller portions during the direct mode connection. However, the transmission occurs at the earliest when the mobile station MSA that has produced and stored the information next arrives at the coverage area of the network. Information can be collected and stored in the mobile station in the same way in the cases shown in FIGS. 1 to 3, if the connection to the network is lost for some reason or if the connection cannot be established to the network.

In the above mobile systems both the mobile station and the network may cause the disconnection of the connection. Reasons for disconnecting the connection are, for example, the end of the traffic, a malfunction wherefore a connection cannot be established, the disappearance of a control channel, the loading or a change in the operation conditions of the network or the cell. Thus, depending on the situation, the direct mode connection can end totally or switch into the standard operation mode of the cellular network, whereafter the communication takes place through the base stations of such a network, within the area of which the mobile station is located.

The mobile system parts shown in FIGS. 1 to 4 can be for example the parts of a TETRA network, but the invention can also be utilized in other connections. FIGS. 1 to 4 only show the parts of the mobile system that are essential to the invention. In addition, the called mobile station can also function as the master mobile station in all the above situations, even if the calling mobile station is by way of example selected as the master in the Figures.

FIG. 5 is a block diagram showing the mobile station trafficking on a direct mode channel of the invention. The mobile station in FIG. 5 corresponds for example to the mobile station MSA shown in FIGS. 1 to 4. Only the parts of the mobile system that are essential to the invention are indicated in the Figure. The mobile station shown comprises a transceiver 50, a control unit 51, a memory 53 and a received signal strength indicator 52.

The transceiver 50 is arranged to send and receive on the channel in use under the control of the control unit 51. The transceiver 50 also comprises an antenna for communication on a radio path. The data on the employed channels may be stored in the memory 53 that the control unit 51 also controls. The control unit 51 may also, if need be, control the switch of the transceiver 50 from direct mode operation to standard cellular network operation. The switch between operation modes may also occur as a response to the control command sent by the network. The switch from the direct mode operation to the use of a connection to be transmitted through base stations may also occur during the connection. Information about the direct mode connection can, if needed, be stored in the memory 53 before the information is conveyed to the network. The memory may then for example be placed in the SIM card, i.e. in the subscriber identity module, which also comprises the data required for identifying the subscriber and for ciphering the radio traffic. The received signal strength indicator 52 is used when roaming within the network area. Said indicator allows the mobile station to perform measurements concerning the surrounding base stations and to initiate a channel for the direct mode connection from the best possible base station on the basis of the measurements.

The mobile station may include in contrast to FIG. 5 several parallel transceivers, if what is known as a multi-purpose mobile station is concerned.

It is obvious for those skilled in the art that as technology progresses the basic idea of the invention can be implemented in various ways. The invention and its preferred embodiments are therefore not restricted to the above examples but may vary within the scope of the claims.

1. A method for handling a connection in a mobile system where a direct mode connection is established between at least two mobile stations (MSA, MSB), characterized by comprising the steps of
allocating an available traffic channel to the direct mode connection through a base station (BS, BSA) of the mobile network in response to a call sent by one of the mobile stations (MSA),
establishing the direct mode connection between the mobile stations (MSA, MSB), and
transmitting information concerning the direct mode connection on a control channel between the base station (BS, BSA) of the mobile network and one of the mobile stations (MSA) during the direct mode connection.

2. A method as claimed in claim 1, characterized by transmitting between the calling mobile station (MSA) and the base station (BS, BSA) information concerning the direct mode connection on the control channel during the direct mode connection, the calling mobile station (MSA) then functioning as the master of the direct mode connection and the called mobile station (MSB) as the slave of the direct mode connection.

3. A method as claimed in claim 1, characterized by transmitting between the called mobile station and the base station (BS, BSA) information concerning the direct mode connection on the control channel during the direct mode connection, the called mobile station then functioning as the master of the direct mode connection and the calling mobile station as the slave of the direct mode connection.

4. A method as claimed in claim 2 or 3, characterized by interchanging the master and slave roles of the direct mode connection during the direct mode connection so that the connection to the base station on the control channel is transferred from the original master to the original slave, and the original slave thus becomes the master of the direct mode connection.

5. A method as claimed in claim 2 to 4, characterized in that the master and the slave mobile stations (MSA, MSB) are within the coverage area of the same base station (BS) in the mobile network, in which case the synchronization of the mobile stations (MSA, MSB) is carried out by sending a synchronization signal from said base station (BS) that is received in the master and slave mobile stations (MSA, MSB).

6. A method as claimed in claim 2 to 4, characterized in that the master and the slave mobile stations (MSA, MSB) are either in the same or in a different mobile network within the coverage area of different base stations (BS, BSA), in which case the synchronization of the mobile stations (MSA, MSB) is carried out by sending from both base stations (BSA, BSB) a synchronization signal so that the synchronization signal sent by the first base station (BSA) is received in the master mobile station (MSA) and the synchronization signal sent by the second base station (BSB) is received in the slave mobile station (MSB).

7. A method as claimed in claim 2 to 6, characterized by checking before the establishment of the direct mode connection that the master and slave mobile stations (MSA, MSB) are located close enough to each other such that the direct mode connection can be established.

8. A method as claimed in claim 2 to 4, characterized in that the master mobile station (MSA) is outside the coverage area of the mobile network and the slave mobile station (MSB) is within the coverage area of the mobile network, in which case a traffic channel is requested from the base station (BS) of the mobile network through the slave mobile station (MSB) and the information about the allocated traffic channel is relayed from the slave mobile station (MSB) to the master mobile station (MSA) and the information concerning the direct mode connection is relayed between the base station (BS) and the master mobile station (MSA) through the slave mobile station (MSB).

9. A method as claimed in claim 1 to 8, characterized in that the information concerning the direct mode connection comprises information about billing, the use of traffic channels and mobility management.

10. A method as claimed in claim 2 to 9, characterized in that the direct mode connection is a group connection, i.e. the number of slave mobile stations (MSB) is at least two.

11. A mobile system including at least two mobile stations (MSA, MSB) comprising means for establishing a direct mode connection, and a mobile network comprising at least one base station (BS, BSA, BSB), characterized by at least one of said mobile stations (MSA) comprising means (50, 51) for producing information concerning a direct mode connection, and means (50) for sending and receiving information concerning the direct mode connection on a control channel of the base station (BS, BSA) of the mobile network during the direct mode connection, and the base station (BS, BSA) of the mobile network comprising means for sending and receiving the information concerning the direct mode connection on the control channel during the direct mode connection.

12. A mobile system as claimed in claim 11, characterized by comprising means for sending a control command to the mobile station in order to replace the direct mode connection with a connection through the base station or base stations.

13. A mobile system as claimed in claim 11 or 12, characterized by comprising means for sending a control command to the mobile station in order to disconnect the direct mode connection.

14. A mobile station comprising a transceiver (50) arranged to send and receive radio signals on a direct mode channel, characterized by comprising means (50, 51) for producing information concerning a direct mode connection, and means (50) for sending and receiving information concerning the direct mode connection on a control channel of a base station (BS, BSA) of a mobile network during the direct mode connection.

15. A mobile station as claimed in claim 14, characterized by also comprising means (53) for storing the information concerning the direct mode connection in the mobile station and means (50) for transmitting the stored information concerning the direct mode connection to the mobile network through the base station (BS, BSA) after the conclusion of the direct mode connection.

16. A mobile station as claimed in claim 14 or 15, characterized by comprising means (52) for performing measurements on the signals received from base stations (BS, BSA, BSB) of the mobile network during the direct mode connection so that the mobile station when trafficking within the mobile network area may using handovers take a channel into use from the best base station (BS, BSA, BSB).

17. A mobile station as claimed in any one of claims 12 to 16, characterized by comprising means (50, 51) for performing paging so that a paging signal allows to reach another mobile station when the mobile station is outside the coverage area of the mobile network.

18. A mobile station as claimed in any one of claims 12 to 17, characterized by comprising means (50, 51) for requesting a traffic channel from the base station (BS, BSA) of the mobile network for a direct mode connection after receiving a call from another mobile station, when the mobile station is within the coverage are of the mobile network, and means (50, 51) for relaying the data about the allocated traffic channel to the mobile station that sent the call, and means for relaying the information concerning the direct mode connection between the base station (BS) and the mobile station that sent the call.

19. A mobile station as claimed in any one of claims 12 to 18, characterized by also comprising means (50, 51) for requesting a traffic channel from the base station (BS, BSA), within whose coverage area the mobile station is located for replacing the direct mode connection by a connection through the base station or the base stations.
